(19) United States
(12) Patent Application Publication
(10) Pub. No.: US 2020/0118302 A1
(43) Pub. Date: Apr. 16, 2020

(54) Display of a single or plurality of picture(s) or visual element(s) as a set or group to visually convey information that otherwise would be typed or written or read or sounded out as words or sentences.

(71) Applicant: Farimehr Schlake, Great Falls, VA (US)

(72) Inventor: Farimehr Schlake, Great Falls, VA (US)

(73) Assignee: Farimehr Schlake, Great Falls, VA (US)

(21) Appl. No.: 16/049,259

(22) Filed: Oct. 10, 2018

(51) Int. Cl. G06T 11/00; G06T 13/80

(52) U.S. Cl. CPC G06T 11/00; H04W 4/80; G06T 13/80

(57) ABSTRACT

The method for creating or using or re-using one or more visual communication unit(s) to visually portray and convey information to be communicated, visually. This visual communication can be in lieu of or in conjunction with other written, and/or spoken, and/or machine language, voice/audible media, and/or any other communication methods. This is done by creating or using one or more visual element(s), picture(s), geometric object(s), painting(s), drawing(s), video(s), movie(s), clip(s), art(s), animation(s), (please note, these are not an exhaustive list of elements), or re-using already made or existing visual communication unit(s), or a combination of, for visually portraying and conveying the information to be communicated, visually. Then communicating the visual communication unit(s) conveying the information visually, through the communication channel(s), tool(s), format(s), and medium(s) of choice.

### TECHNICAL FIELD

Certain embodiments of the present disclosure generally relate to communications, visual communications, digital communication, telecommunications, instant messaging, messaging, computer and scientific, and Information Technology.

### BACKGROUND

To convey information in communications today, primarily written and/or spoken language in form of voice or written words and sentences utilizing alphabet and numbers are used. Globally, there is a language barrier for communication. Different countries have different languages and to communicate with their people, devices, and applications, in written and/or spoken language, both parties need to know that particular language or agree upon another mutually known language.

In addition, digital and Instant Messaging (IM), texting, and emails follow the same pattern. Typing long sentences and paragraphs is time consuming. Reading those long messages even more cumbersome. Especially in real time and at fast pace. Moreover, much of the daily communication needs are repetitive and re-occurring.

Our increasing mobile phone usage adds up to this discomfort and the need of fast typing. Using the small keys on the phone adds to this unease. The mobile phone use also has introduced a new hazard of texting, while operating attention needing devices, such as texting while driving.

Time has become a commodity in our daily lives. The speed and timing of the communication is increasingly of importance. In many situations, this can be cut short, since just one quick status update suffices, if we had a right communication tool.

Both speed and ease of communication are of paramount importance in emergency situations, where there is no time for typing.

Furthermore, people with special needs, developmentally disabled or people with acquired disabilities and regenerative and/or brain damaging diseases generally convey their information better and easier through visual communications and for some, this is the only viable way of communications.

### SUMMARY OF DISCLOSURE

Certain embodiments provide a method generally including creating one or more visual communication unit(s) to visually portray and convey information visually. Generally creating or using one or more visual element(s), picture (s), geometric object(s), painting(s), drawing(s), video(s), movie(s), clip(s), art(s), animation(s), (please note, these are not an exhaustive list of elements), or generally re-using already made or existing visual communication unit(s), or a combination of, for visually portraying and conveying the information to be communicated visually. Then, generally communicating the visual communication unit(s) conveying the information visually through the communication channel(s), tool(s), format(s), and medium/media of choice.

Certain embodiments provide a method explained above generally in conjunction with or in lieu of written and/or spoken language, sign language, Braille language, bar code, or any machine language, any scripting language, alphabets, numbers, symbols, words, sentences, voice, sound, music, any audibles or any combination of, in the information to be conveyed and/or the visual communication units.

Certain embodiments provide a method explained above generally including a frame around the visual communication unit(s), if chosen to do so.

Certain embodiments provide a method explained above generally including any visual and image format, such as jpeg, png, tiff, gif, and/or else (these are not an exhaustive list of available formats).

Certain embodiments provide a method explained above generally including any animation, movie or video format, such as gif, apng, webp, mng, flif, and/or else (these are not an exhaustive list of available formats).

Certain embodiments provide a method explained above generally including communicating through the communication channel(s), tool(s), format(s), and medium/media of choice, such as email, instant messaging, texting, facetime, mobile, cellular, satellite, landline, cable, phone, computers, networks, any form of communications, Artificial Intelligence (AI) and cyber tools, optical communications, or else (these are not an exhaustive list of available communication channels, tools and media).

Certain embodiments provide a method generally visually portraying and including conveying information, visually, using/re-using visual communication unit(s). Generally creating or using/re-using one or more visual element(s), picture (s), geometric object(s), painting(s), drawing(s), video(s), movie(s), clip(s), art(s), animation(s), (these are not an exhaustive list of elements), or generally re-using already made or existing visual communication unit(s), or a combination of, for visually portraying and conveying the information to be communicated visually. Then, generally communicating the visual communication unit(s) conveying the information visually through the communication channel(s), tool(s), format(s), and medium/media of choice.

Certain embodiments provide a method explained above in paragraph [0014] generally in conjunction with or in lieu of written and/or spoken language, sign language, Braille language, bar code, or any machine language, any scripting language, alphabets, numbers, symbols, words, sentences, voice, sound, music, any audibles or any combination of, in the information to be conveyed and/or the visual communication units.

Certain embodiments provide a method explained above in paragraph [0015] generally including a frame around the visual communication unit(s), if chosen to do so.

Certain embodiments provide a method explained above in paragraph [0016] generally including any visual and image format, such as jpeg, png, tiff, gif, and/or else (these are not an exhaustive list of available formats).

Certain embodiments provide a method explained above in paragraph [0016] generally including any animation, movie or video format, such as gif, apng, webp, mng, flif, and/or else (these are not an exhaustive list of available formats).

Certain embodiments provide a method explained above in paragraph [0016] generally including communicating through the communication channel(s), tool(s), format(s), and medium/media of choice, such as email, instant messaging, texting, facetime, mobile, cellular, satellite, landline, cable, phone, computers, networks, any other form of communications, Artificial Intelligence (AI) and cyber tools, optical communications, or else (these are not an exhaustive list of available communication channels, tools and media).

Certain embodiments of this disclosure provide a method generally including eliminating the need for typing of words and sentences, and the use of written, and/or spoken language. These introduce ease of communication. These units generally may be re-used as needed in the same re-occurring situations, fast and easily, conveying the same information.

Certain embodiments of this disclosure provide a method generally including providing the means for rapid communications, hence saving time.

Certain embodiments of this disclosure provide a method generally including providing the means for rapid communications, hence saving lives in emergency situations.

Certain embodiments of this disclosure provide a method generally including providing the means for rapid communications, hence saving lives in situations, where attention needing handling of machinery is needed, such as in case of driving and texting while driving.

Certain embodiments of this disclosure provide a method generally including providing the means for visual communications, for people with special needs, developmentally disabled or people with acquired disabilities and regenerative and/or brain damaging diseases, who generally convey their information better and easier through visual communications, and for whom, this visual communication is the only viable way of communications.

Certain embodiments of this disclosure provide a method generally including the use of the visual communication unit(s) for communications within, and/or between, and/or among human bodies, organic structures, inorganic structures, computers, phones, any form of communication device, gadgets, wearable technologies, watches, glasses, sensors, actuators, processors, microprocessors, toys, vehicles, any devices and hardware, any software, appliances, any structures, tools, buildings, monitors, keyboards, mice, any parts of a system (please note, this list is not an exhaustive list of possible tools, structures, and applications).

Certain embodiments of this disclosure provide a method generally including generating, creating, using or re-using the visual communication unit(s) by the above in paragraph

mentioned tools, structures, and applications for communications within, and/or between, and/or among above in paragraph [0025] mentioned tools, structures and applications.

### BRIEF DESCRIPTION OF THE DRAWINGS

A more particular description of the disclosure, briefly summarized above, can be had by reference to the embodiments of this disclosure, some of which are illustrated as examples of drawings, so that the recited features of the present disclosure can be understood in more detail. Please note, however, that the appended drawings are only examples and illustrate typical embodiments of this disclosure and therefore in no way limiting of its scope and diversity of ways to create and illustrate these embodiments. The disclosure may admit to other equally effective embodiments.

FIG. 1 illustrates an example of the proposed conveying of information through visual communication in lieu of written and/or spoken language, writing or typing or method of conveying through voice, in accordance with certain embodiments of the present disclosure. The visual elements in this visual communication unit are created and/or used to sufficiently visually portray and convey the following information: “I need Help! Please call Emergency/Medics.”

FIG. 2 illustrates an example of the proposed conveying of information through visual communication in lieu of written and/or spoken language, writing or typing or method of conveying through voice, in accordance with certain embodiments of the present disclosure. The visual elements in this visual communication unit are created and/or used to sufficiently visually portray and convey the following information: “On the Way Home!”

FIG. 3 illustrates an example of the proposed conveying of information through visual communication in lieu of written and/or spoken language, writing or typing or method of conveying through voice, in accordance with certain embodiments of the present disclosure. The visual elements in this visual communication unit are created and/or used to sufficiently visually portray and convey the following information: “There is a Robbery! Call the Police!”

FIG. 4 illustrates an example of the proposed conveying of information through visual communication in lieu of written and/or spoken language, writing or typing or method of conveying through voice, in accordance with certain embodiments of the present disclosure. The visual elements in this visual communication unit are created and/or used to sufficiently visually portray and convey the following information: “I am at the Hospital!”

FIG. 5 illustrates an example of the proposed conveying of information through visual communication in lieu of written and/or spoken language, writing or typing or method of conveying through voice, in accordance with certain embodiments of the present disclosure. The visual elements in this visual communication unit are created and/or used to sufficiently visually portray and convey the following information: “Staying after school for band/music!”

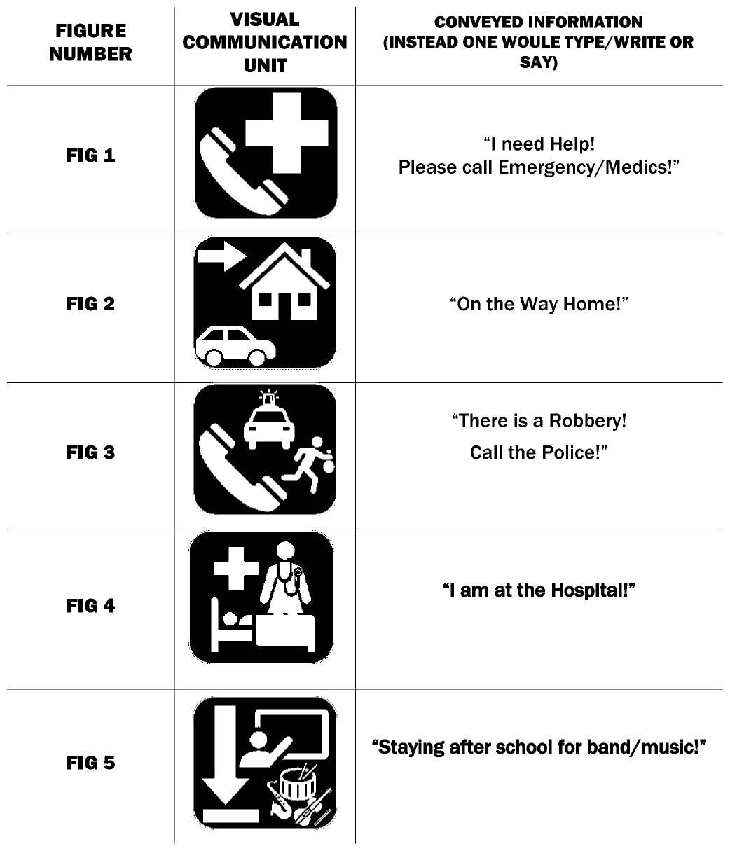

### DETAILED DESCRIPTION AND USE CASES

### Detailed Description

Embodiments of the present disclosure may create one or more visual communication unit(s) to visually portray and convey information visually. This may be done by creating or using one or more visual element(s), picture (s), geometric object(s), painting(s), drawing(s), video(s), movie(s), clip(s), art(s), animation(s), (please note, these are not an exhaustive list of elements), or re-using already made or existing visual communication unit(s), or a combination of, for visually portraying and conveying the information to be communicated visually. Then, these visual communication unit(s) may be communicated, conveying the information visually, through the communication channel(s), tool(s), format(s), and medium/media of choice.

Embodiments of the present disclosure may be visually portraying and including conveying information, visually, using/re-using visual communication unit(s). This may be done by creating or using/re-using one or more visual element(s), picture (s), geometric object(s), painting(s), drawing(s), video(s), movie(s), clip(s), art(s), animation(s), (these are not an exhaustive list of elements), or re-using already made or existing visual communication unit(s), or a combination of, for visually portraying and conveying the information to be communicated visually. Then, these visual communication unit(s) may be communicated, conveying the information visually, through the communication channel(s), tool(s), format(s), and medium/media of choice.

In certain embodiments of the present disclosure, the visual communication unit(s), and/or the information to be conveyed may be in lieu of or in conjunction with spoken, and/or written language, sign language, Braille language, bar code, or any machine language, any scripting language, alphabets, numbers, symbols, words, sentences, voice, sound, music, any audibles or any combination of.

Embodiments of the present disclosure may include a frame around the visual communication unit(s), if chosen to do so.

Embodiments of the present disclosure may be in any visual and image format, such as jpeg, png, tiff, gif, and/or else (these are not an exhaustive list of available formats).

Embodiments of the present disclosure may be in any animation, movie or video format, such as gif, apng, webp, mng, flif, and/or else (these are not an exhaustive list of available formats).

Embodiments of the present disclosure may be communicated through the communication channel(s), tool(s), format(s), and medium/media of choice, such as email, instant messaging, texting, facetime, mobile, cellular, satellite, landline, cable, phone, computers, networks, any form of communications, Artificial Intelligence (AI) and cyber tools, optical communications, or else (these are not an exhaustive list of available communication channels, tools and media).

Embodiments of the present disclosure may use the visual communication unit(s) for communications within, and/or between, and/or among human bodies, organic structures, inorganic structures, computers, phones, any form of communication device, gadgets, wearable technologies, watches, glasses, sensors, actuators, processors, microprocessors, toys, vehicles, any devices and hardware, any software, appliances, any structures, tools, buildings, monitors, keyboards, mice, any parts of a system (please note, this list is not an exhaustive list of possible tools, structures, and applications).

Embodiments of the present disclosure may create, use or re-use the visual communication unit(s) by the above in paragraph [0040] mentioned tools, structures, and applications for communications within and/or between and/or among above in paragraph [0025] mentioned tools, structures and applications.

### Use Cases

Embodiments of the present disclosure may allow fast communication to take place. The proposed visual communication may eliminate the need for any type of written and/or spoken language, typing, and/or writing, words and sentences, however, they can be included, if chosen to do so. Having to type words and sentences as the only way for communication may introduce danger in many use cases, where attention in operating devices and applications is required, such as in case of texting while driving.

Furthermore, daily communication and status update may consist of many repetitive sentences, that may be conveyed through one visual unit. Some communication may need more of these units to be used, depending on the particular embodiments of the present disclosure created and used. This/These unit(s) may be re-used as needed in the same re-occurring situations, fast and easily, conveying the same information.

Embodiments of the present disclosure may be used in emergency, alert systems, Personal Emergency Response Systems (PERS), and disaster recovery situations, where rapid communication may be of utmost importance and typing and texting is cumbersome and many times impossible.

Embodiments of the present disclosure may be also used in applications and device communications with Application-to-People (A2P), People-to-Application (P2A), Application-to-Application (A2A), and/or device to device, and/or system-to-system, and/or organic structure-to-structure, and/or in-organic structure-to-structure, (please note, these are not an exhaustive list of applications and devices). It may be used for any status updates and customer relationship management, event planning and reminder communications. This fast and easy visual communication may benefit consumers and enterprises the same. Healthcare, doctors, educational, law enforcement, work force, field force, sales and marketing, transportation, logistics, finance, and global governments may benefit from this rapid method of visual communication.

Embodiments of the present disclosure may be also used in tools, structures, applications and device communications within, and/or between, and/or among human bodies, organic structures, inorganic structures, computers, phones, any form of communication device, gadgets, wearable technologies, watches, glasses, sensors, actuators, processors, microprocessors, toys, vehicles, any devices and hardware, any software, appliances, any structures, tools, buildings, monitors, keyboards, mice, any parts of a system (please note, this list is not an exhaustive list of possible tools, structures, and applications).

Embodiments of the present disclosure may eliminate the language barrier in international and global communications. Visual communication may mostly convey the same information and may be interpreted easily without language barrier across the globe. People of different regions, countries, cultures, spoken languages and dialects may communicate with each other effortlessly using this visual communication.

Please note, the above use cases are only examples of many and in no means limiting the scope of implementation of the embodiments of the present disclosure.

1. A method for creating one or more visual communication unit(s) to visually portray and convey information visually, introducing an enhanced universal mode of communications, eliminating necessity of using written or spoken language or sign language for the ability to communicate, eliminating global comprehension problem of diverse languages, among other improvements listed in this section and in the specifications section of this application, comprising:
a. Creating or using one or more illustrative element(s) such, but not limited to, visual element(s), picture(s), geometric object(s), painting(s), drawing(s), video(s), movie(s), clip(s), art(s), animation(s), song(s), in visual communication unit(s), or re-using already made or existing visual communication unit(s), or a combination of, for visually portraying, and conveying the information to be communicated visually. This is done to transform such, but not limited to, instant messaging, texting, notifications, and alerts communication technologies and establish an improved, universally comprehensible, more convenient, faster and easier to use and to comprehend communications. This is done by:
i. Selecting a user communication text to be conveyed visually
The text to be conveyed may be entered in such way, but not limited to, typed text, recognized handwriting, transcribed speech, sound, and voice, which is entered into a smart device or software via, but not limited to, keyboard, file transfer, application download, software tools, storage access, network access, from the cloud, or remote server.
ii. Determining language of the user communication text
This determination may be done through expert human interaction and/or with use of software tools and algorithms such as, but not limited to, Natural Language Processing (NLP) tool, available for smart devices and computers.
iii. Analyzing structural elements of the user communication text
This analysis is done to determine the structural elements of the text, such as, but not limited to, subject, object, action verb, time and date, question or statement. This analysis may be done through expert human interaction and/or with use of software tools and algorithms such as, but not limited to, Natural Language Processing (NLP) tool, available for smart devices and computers.
iv. Associating the structural elements to the question words
The results of the analysis of step (1.a.iii) will be associated to visual communication unit building block keywords of: WHO, WHEN, WHAT, HOW, WHERE (at, to, or from), STATUS (statement or question) either through expert human interaction and/or through use of software tools, which facilitate this association through such, but not limited to, reading out of databases, tables or using meta-data associations, software tools, and smart device searches, etc.
v. Selecting and associating illustrative element(s) to the question words
This selecting and associating illustrative element(s), such as, but not limited to the list in (1.a.), to the question words' answers may be done using graphical software tools such as, but not limited to sketch, power point, photoshop, illustrator, etc. Searching and finding the right illustrative element may be done through expert human interaction with software tools and smart devices or by use of software tools conducting this step through such, but not limited to, reading out of databases, tables, folders, storage, cloud, software tools, or using meta-data associations, and smart device searches.
vi. Forming a visual communication unit
To group and convey the information visually with the selected illustrative element(s) of step (1.a.v.) a visual communication unit may be formed using a frame using graphical software tools such as, but not limited to sketch, power point, photoshop, illustrator, etc. This may be done through expert human interaction with software tools and smart devices or by use of software tools conducting this step through such, but not limited to, reading out of databases, tables, folders, cloud, storage, software tools, or using meta-data associations, and smart device searches. If a more general visual communication unit is built, illustration of subject of the action verb (WHO) may be eliminated. A more detailed visual communication unit includes illustrative element(s), such as, but not limited to the list in (1.a.), which illustrate subject of the action verb (WHO).
b. Communicating the visual communication unit(s) conveying the information visually through communication channel(s), tool(s), format(s), and medium/media of choice.

2. The method of claim 1 wherein the step (a.) is done in conjunction with or in lieu of spoken and/or written language, Braille language, bar code, or any machine language, any scripting language, alphabets, numbers, symbols, words, sentences, voice, sound, music, any audibles or any combination of, in the information to be conveyed and/or the visual communication units.

3. The method of claim 2 further comprising a frame around the visual communication unit. The frame may be drawn using graphical software tools such as, but not limited to, sketch, power point, photoshop, illustrator. The frame may also be selected from already made, in distribution and commercialized visual elements, purchased or licensed to be used.

4. The method of claim 3 wherein the visual communication unit(s) is/are in any visual and image format(s), such as, but not limited to, jpeg, png, tiff, gif.

5. The method of claim 3 wherein the visual communication unit(s) comprise(s) any animation, movie or video format(s), such as, but not limited to, gif, apng, webp, mng, flif.

6. The method of claim 4 wherein the communicating step (b.) of claim 1 is done through communication channel, format and medium of choice, such as, but not limited to, email, instant messaging, texting, facetime, mobile, cellular, satellite, landline, cable, phone, computers, networks, any form of communications, books, manuals, reports, scripts, flyers, notes, memos, notifications, alerts, software tools, Artificial Intelligence and cyber tools, optical communications.

7. The method of claim 5 wherein the communicating step (b.) of claim 1 is done through communication channel, format and medium of choice, such as, but not limited to, email, instant messaging, texting, facetime, mobile, cellular, satellite, landline, cable, phone, computers, networks, any form of communications, books, manuals, reports, scripts, flyers, notes, memos, notifications, alerts, software tools, Artificial Intelligence and cyber tools, optical communications.

8. A method of visually portraying and conveying information visually, using/re-using visual communication unit(s), introducing an enhanced universal mode of communications, eliminating necessity of using written or spoken language or sign language for the ability to communicate, eliminating global comprehension problem of diverse languages, among other improvements listed in this section and in the specifications section of this application, comprising:
a. Re-using or using one or more illustrative element(s), such, but not limited to, visual element(s), picture(s), geometric object(s), painting(s), drawing(s), video(s), movie(s), clip(s), art(s), animation(s), or re-using or modifying already made or existing visual communication unit(s), or a combination of, for visually portraying and conveying the information to be communicated visually. This is done to transform such, but not limited to, instant messaging, texting, notifications, and alerts communication technologies and establish an improved, universally comprehensible, more convenient, faster and easier to use and to comprehend communications. This is done by:
i. Selecting a user communication text to be conveyed visually
The text to be conveyed may be entered in such way, but not limited to, typed text, recognized handwriting, transcribed speech, sound, and voice, which is entered into a smart device or software via, but not limited to, keyboard, file transfer, application download, software tools, storage access, network access, from the cloud, or remote server.
ii. Determining language of the user communication text
This determination may be done through expert human interaction and/or with use of software tools and algorithms such as, but not limited to, Natural Language Processing (NLP) tool, available for smart devices and computers.
iii. Analyzing structural elements of the user communication text
This analysis is done to determine the structural elements of the text, such as, but not limited to, subject, object, action verb, time and date, question or statement. This analysis may be done through expert human interaction and/or with use of software tools and algorithms such as, but not limited to, Natural Language Processing (NLP) tool, available for smart devices and computers.
iv. Associating the structural elements to the question words
The results of the analysis of step (8.a.iii) will be associated to visual communication unit building block keywords of: WHO, WHEN, WHAT, HOW, WHERE (at, to, or from), STATUS (statement or question) either through expert human interaction and/or through use of software tools, which facilitate this association through such, but not limited to, reading out of databases, tables or using meta-data associations, software tools, and smart device searches, etc.
v. Selecting and associating illustrative element(s) to the question words
This selecting and associating illustrative element(s), such as, but not limited to the list in (8.a.), to the question words' answers may be done using graphical software tools such as, but not limited to sketch, power point, photoshop, illustrator, etc. Searching and finding the right illustrative element may be done through expert human interaction with software tools and smart devices or by use of software tools conducting this step through such, but not limited to, reading out of databases, tables, folders, storage, cloud, software tools, or using meta-data associations, and smart device searches.
vi. Forming a visual communication unit
To group and convey the information visually with the selected illustrative element(s) of step (8.a.v.) a visual communication unit may be formed using a frame using graphical software tools such as, but not limited to sketch, power point, photoshop, illustrator, etc. This may be done through expert human interaction with software tools and smart devices or by use of software tools conducting this step through such, but not limited to, reading out of databases, tables, folders, cloud, storage, software tools, or using meta-data associations, and smart device searches. If a more general visual communication unit is built, illustration of subject of the action verb (WHO) may be eliminated. A more detailed visual communication unit includes illustrative element(s), such as, but not limited to the list in (8.a.), which illustrate subject of the action verb (WHO).
b. Communicating the visual communication unit(s) conveying the information visually through communication channel(s), tool(s), format(s), and medium/media of choice.

9. The method of claim 8 wherein the step (a.) is done in conjunction with or in lieu of spoken and/or written language, Braille language, bar code, or any machine language, any scripting language, alphabets, numbers, symbols, words, sentences, voice, sound, music, any audibles or any combination of, in the information to be conveyed and/or the visual communication units.

10. The method of claim 9 further comprising a frame around the visual communication unit. The frame may be drawn using graphical software tools such as, but not limited to, sketch, power point, photoshop, illustrator. The frame may also be selected from already made, in distribution and commercialized visual elements, purchased or licensed to be used.

11. The method of claim 10 wherein the visual communication unit(s) is/are in any visual and image format(s), such as, but not limited to, jpeg, png, tiff, gif.

12. The method of claim 10 wherein the visual communication unit(s) comprise(s) such, but not limited to, any animation, movie or video format(s), such as, but not limited to, gif, apng, webp, mng, flif.

13. The method of claim 11 wherein the communicating step (b.) of claim 8 is done through communication channel, format and medium of choice, such as, but not limited to, email, instant messaging, texting, facetime, mobile, cellular, satellite, landline, cable, phone, computers, networks, any form of communications, books, manuals, reports, scripts, flyers, notes, memos, notifications, alerts, software tools, Artificial Intelligence and cyber tools, optical communications.

14. The method of claim 12 wherein the communicating step (b.) of claim 8 is done through communication channel, format and medium of choice, such as, but not limited to, email, instant messaging, texting, facetime, mobile, cellular, satellite, landline, cable, phone, computers, networks, any form of communications, books, manuals, reports, scripts, flyers, notes, memos, notifications, alerts, software tools, Artificial Intelligence and cyber tools, optical communications.

15. The method of claim 3 wherein the visual communication unit(s) is/are used for communications within, and/or between, and/or among users, such, but not limited to, human bodies, organic structures, inorganic structures, computers, phones, any form of communication device, gadgets, wearable technologies, watches, glasses, sensors, actuators, processors, microprocessors, toys, vehicles, any devices and hardware, any software, appliances, any structures, tools, buildings, monitors, keyboards, mice, any parts of a system.

16. The method of claim 3 wherein the visual communication unit(s) is/are created, generated, used/re-used manually, and/or within, and/or by such, but not limited to, computers, phones, any form of communication device, gadgets, wearable technologies, watches, glasses, sensors, actuators, processors, microprocessors, toys, vehicles, any devices and hardware, any software, appliances, any structures, tools, buildings, monitors, keyboards, mice, any parts of a system human bodies, organic structures, inorganic structures, for communications within, and/or between, and/or among these tools and applications.

17. The method of claim 10 wherein the visual communication unit(s) is/are used for communications within, and/or between, and/or among users, such, but not limited to, human bodies, organic structures, inorganic structures, computers, phones, any form of communication device, gadgets, wearable technologies, watches, glasses, sensors, actuators, processors, microprocessors, toys, vehicles, any devices and hardware, any software, appliances, any structures, tools, buildings, monitors, keyboards, mice, any parts of a system.

18. The method of claim 10 wherein the visual communication unit(s) is/are created, generated, used/re-used within, and/or by such, but not limited to, human bodies, organic structures, inorganic structures, computers, phones, any form of communication device, gadgets, wearable technologies, watches, glasses, sensors, actuators, processors, microprocessors, toys, vehicles, any devices and hardware, any software, appliances, any structures, tools, buildings, monitors, keyboards, mice, any parts of a system, for communications within, and/or between, and/or among these tools and applications.
